(19) United States
(12) Patent Application Publication
(10) Pub. No.: US 2026/0198570 A1
(43) Pub. Date: Jul. 16, 2026

(54) AEROSOL-GENERATING ARTICLE WITH A PLANAR FRAME

(71) Applicant: Philip Morris Products S.A., Neuchatel (CH)

(72) Inventors: Rui Nuno Rodrigues Alves BATISTA, Morges (CH); Semen GURALEVYCH, Lausanne (CH)

(73) Assignee: Philip Morris Products S.A., Neuchatel (CH)

(21) Appl. No.: 19/136,937

(22) PCT Filed: Dec. 21, 2023
(86) PCT No.: PCT/EP2023/087360

§ 371 Date: Jun. 9, 2025

(30) Foreign Application Priority Data
Dec. 23, 2022 (EP) 22216422.0

(51) Int. Cl. A24F 40/42; A24F 40/30; A24F 40/48

(52) U.S. Cl. CPC A24F 40/42; A24F 40/30; A24F 40/48

(57) ABSTRACT

An aerosol-generating article for an aerosol-generating device to form an inhalable aerosol is provided, the aerosol-generating article including a planar frame and an aerosol-generating substrate, the planar frame including: a top surface, a bottom surface, and lateral sides, an inlet disposed on a lateral side, an outlet disposed on a lateral side opposing the inlet, a recess between the inlet and the outlet, and an opening on the top surface, the aerosol-generating substrate being disposed in the recess, and the aerosol-generating substrate being smaller than the opening. An aerosol-generating system including a device and the aerosol-generating article is also provided.

The disclosure relates to an aerosol-generating article and an aerosol-generating system comprising an aerosol-generating device and an aerosol-generating article.

Some known aerosol-generating systems comprise an aerosol-generating device having a power supply, such as a battery, a controller, and a heating element for heating an aerosol-generating substrate. In some examples, the aerosol-generating substrate comprises a tobacco rod or a tobacco plug that is arranged in an aerosol-generating article. In use, the aerosol-generating article is inserted into a cavity of the aerosol-generating device, and the heating element either penetrates the aerosol-generating substrate or is arranged around the outside of the aerosol-generating substrate. Power is supplied to the heating element from the power supply to heat the aerosol-generating substrate, and volatile components of the aerosol-generating substrate are vaporised and released and condense to form an aerosol, which is inhalable by a user. In some such aerosol-generating systems, the aerosol-generating article resembles a conventional cigarette, having a similar cylindrical stick like configuration. This known aerosol-generating article is not easily manufactured, nor easily personalised by a user.

It would be desirable to provide an improved aerosol-generating article for use with an aerosol-generating device.

According to the disclosure there is provided an aerosol-generating article for use with an aerosol-generating device to form an inhalable aerosol. The aerosol-generating article may comprise a planar frame. The aerosol-generating article may comprise an aerosol-generating substrate. The planar frame may comprise a top surface. The planar frame may comprise a bottom surface. The planar frame may comprise lateral sides. The planar frame may comprise an inlet. The inlet may be disposed on a lateral side. The planar frame may comprise an outlet. The outlet may be disposed on a lateral side. The outlet may be disposed on a lateral side opposing the inlet. The planar frame may comprise a recess. The recess may be between the inlet and the outlet. The planar frame may comprise an opening. The opening may be on the top surface. The aerosol-generating substrate may be disposed in the recess. The aerosol-generating substrate may be smaller than the opening.

According to the disclosure there is provided an aerosol-generating article for use with an aerosol-generating device to form an inhalable aerosol, the aerosol-generating article comprising a planar frame and an aerosol-generating substrate,

the planar frame comprising:
a top surface, a bottom surface and lateral sides;
an inlet disposed on a lateral side,
an outlet disposed on a lateral side opposing the inlet;
a recess between the inlet and the outlet;
and an opening on the top surface;

wherein the aerosol-generating substrate is disposed in the recess, and the aerosol-generating substrate is smaller than the opening.

This aerosol-generating article has the following advantages:
The article allows for improved ease of use, because a user can easily insert aerosol-generating substrate into the frame, through the opening into the recess. The opening and recess of the planar frame provide an easy to use user interface.
The article can be personalised. During each user experience, the user can choose a particular aerosol-generating substrate or other media, or a combination of aerosol-generating substrates or other media, and decide which to use with the frame, or to decide the location of different aerosol-generating substrates or other media within the frame. Different locations of aerosol-generating substrates (for example, one closer to the air outlet than the other) can provide different user experiences. A user can choose, for example, different aerosol-generating segments or different flavour segments. Personalisation of the article does not detrimentally affect properties such as air flow through the article.
The planar frame shape of the article can be easy to produce and can have a low cost of manufacture compared to a rod-shaped article. A rod-shaped article can be made of several plugs wrapped together, each plug having a specific function (such as cooling, filtering), each plug requiring a dedicated manufacturing process.
The planar frame is compact and versatile, improving the experience of the user.

As used herein, “planar” refers to a feature generally formed in a single Euclidean plane and not wrapped around or otherwise conformed to fit a curved or other non-planar shape. A planar surface extends in two dimensions in a single Euclidean plane. A planar object extends in two dimensions in a single Euclidean plane substantially more than in a third dimension perpendicular to the plane. More specifically, a planar object extends in a first dimension and a second dimension perpendicular to the first dimension at least two, five or ten times further than the object extends in a third dimension perpendicular to the first and second dimensions. Advantageously, planar components of a heating assembly may be easily handled during manufacture and provide for a robust construction.

As used herein, “aerosol-generating device” refers to a device that interacts with an aerosol-generating substrate to generate an aerosol.

As used herein, “aerosol-generating substrate” refers to a substrate capable of releasing volatile compounds that can form an aerosol. Such volatile compounds may be released by heating the aerosol-generating substrate. An aerosol-generating substrate is typically part of an aerosol-generating article.

As used herein, “aerosol-generating article” refers to an article comprising an aerosol-generating substrate that is capable of releasing volatile compounds that can form an aerosol. For example, an aerosol-generating article may be an article that generates an aerosol that is directly inhalable by the user drawing on a mouthpiece at a proximal or mouth end of the aerosol-generating article, an aerosol-generating device, or an aerosol-generating system. An aerosol-generating article may be disposable.

As used herein, “aerosol-generating system” refers to the combination of an aerosol-generating device with an aerosol-generating article. In an aerosol-generating system, the aerosol-generating article and the aerosol-generating device co-operate to generate an aerosol.

As used herein, “proximal” refers to a user end, or mouth end of the aerosol-generating device, aerosol-generating article, or aerosol-generating system. The proximal end of a component of an aerosol-generating device, an aerosol-generating article, or an aerosol-generating system is the end of the component closest to the user end, or mouth end of the aerosol-generating device, the aerosol-generating article, or the aerosol-generating system. As used herein, “distal” refers to the end opposite the proximal end.

As used herein, “end” and “side” are used interchangeably to refer to extremities of a feature, such as an aerosol-generating device, a heating assembly, a heating element, or an aerosol-generating article. Preferably, features described herein have two opposing ends and at least one side extending between the two opposing ends. Preferably, features described herein have a length extending in a longitudinal direction between opposing ends, and a width extending in a transverse direction between two opposing sides.

As used herein, “top surface” and “bottom surface” are relative terms used to refer to opposing surfaces of a feature, such as an aerosol-generating device, a heating assembly, a heating element, an aerosol-generating article, or a planar frame. The top surface can be located above the bottom surface during normal use of the feature, though it will be appreciated that alternative orientations of the feature during use are possible. The top surface may be an upper surface. The bottom surface may be a lower surface.

As used herein, “length” refers to the maximum dimension of a feature in a longitudinal direction of the feature.

As used herein, “width” refers to the maximum dimension of a feature in a transverse direction of the feature. The transverse direction is perpendicular to the longitudinal direction.

As used herein, “thickness” and “depth” refer to the maximum dimension of a feature in a direction perpendicular to the longitudinal direction of the feature and perpendicular to the transverse direction of the feature. The terms “thickness” and “depth” may be used interchangeably herein.

As used herein, the term “aerosol former” may refer to any suitable known compound or mixture of compounds that, in use, facilitates formation of an aerosol. The aerosol may be a dense and stable aerosol. The aerosol may be substantially resistant to thermal degradation at the operating temperature of the aerosol-generating substrate or aerosol-generating article. Suitable aerosol formers for inclusion in the aerosol-generating substrate are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate. Glycerol may be particularly preferable as an aerosol former. Aerosol former contents described with respect to the first and second aerosol-generating substrates may equally be considered glycerol contents.

As used herein, the term “aerosol former content” may refer to aerosol former content in percent on a dry weight basis, unless otherwise specified. The aerosol former content of the first aerosol-generating substrate is based on the weight of the first aerosol-generating substrate, and the aerosol former content of the second aerosol-generating substrate is based on the weight of the second aerosol-generating substrate.

As used herein, the terms “upstream” and “downstream” may refer to the relative positions of elements, or portions of elements, in relation to the direction in which the air or aerosol is transported through the aerosol-generating article during use.

As used herein, the term “bulk density” may refer to bulk density on a dry weight basis, unless otherwise specified. The bulk density of an aerosol-generating substrate or segment can be calculated by measuring or otherwise determining the total dry weight of the aerosol-generating substrate or segment and dividing this by the volume of the aerosol-generating segment substrate or segment.

At least 50 weight percent of the aerosol-generating article may be paper or cardboard. At least 55 weight percent, or at least 60 weight percent, or at least 65 weight percent, or at least 70 weight percent, or at least 75 weight percent, or at least 80 weight percent, or at least 85 weight percent, or at least 90 weight percent of the aerosol-generating article, excluding the aerosol-forming substrate, may be paper or cardboard.

The aerosol-generating substrate may be disposed in the recess of the aerosol-generating article such that at least one side of the aerosol-generating substrate is exposed between the inlet and the outlet as the article is inserted into a device. The aerosol-generating substrate may be disposed in the recess such that at least one side of the aerosol-generating substrate is visible between the inlet and the outlet as the article is inserted into a device. The recess may be configured such that a user can insert aerosol-generating substrate directly into the planar frame through the opening, without needing to open a lid, cover, or ceiling, or remove any other component obscuring the aerosol-generating substrate in the recess. The recess may be configured such that a user can directly remove aerosol-generating substrate from the planar frame through the opening. The aerosol-generating article may be configured such that the opening remains open as the aerosol-generating article is inserted into a device. The aerosol-generating article may be configured such that the opening remains open until the aerosol-generating article is inserted into a device, at which point it may be partially or wholly covered by the device.

The frame may comprise a planar base. The frame may comprise a perimeter wall. The base and the perimeter wall may define the recess.

The frame may be substantially flat. The frame may be substantially elongate. The frame may have at least two substantially parallel outer edges. The frame may have at least two pairs of substantially parallel outer edges. The frame may have a substantially parallelepiped shape. The frame may have a length, a width and a depth. The length may be bigger than each of the width and the depth. The frame may be elongate along a frame length. The frame may have a rectangular cross-section. The frame may have a rectangular lateral cross-section, the lateral cross-section being aligned with the frame width and the frame thickness. A longitudinal axis along the length of the frame may be a normal to a plane of the lateral cross-section.

The inlet and the outlet may be disposed at opposite ends of the length of the frame. The inlet may be disposed at an upstream end of the frame. The inlet may be disposed at a distal end of the frame. The outlet may be disposed at a downstream end of the frame. The outlet may be disposed at a proximal end of the frame. The inlet may be disposed at an end of the frame which is perpendicular to the length of the frame. The outlet may be disposed at an end of the frame which is perpendicular to the length of the frame. The frame may have a longitudinal axis. The longitudinal axis may be a central axis aligned with a length of the frame. The inlet may be intersected by the longitudinal axis. The inlet may be arranged so that the longitudinal axis intersects a central point of the inlet. The inlet may be offset from the longitudinal axis. The outlet may be intersected by the longitudinal axis. The outlet may be arranged so that the longitudinal axis intersects a central point of the outlet. The outlet may be offset from the longitudinal axis. The inlet may be offset from the outlet. Offsetting the inlet or outlet (or inlet and outlet) from each other has the advantage of increasing air turbulence within the article, which improves mixing of ambient air with aerosol generated by the heated aerosol-generating substrate.

A ratio of the frame width to the frame thickness may be at least about 3:1. A ratio of the frame width to the frame thickness may be at most about 30:1. A ratio of the frame width to the frame thickness may be between about 3:1 and about 30:1. A ratio of the frame width to the frame thickness may be about 30:3. A ratio of the frame length to the frame width may be at least about 1:1. A ratio of the frame length to the frame width may be at most about 5:1. A ratio of the frame length to the frame width may be between about 1:1 and about 5:1. A ratio of the frame length to the frame width may be about 5:1.

The frame may have a thickness of at least about 1 millimetre. The frame may have a thickness of at most about 3 millimetres. The frame may have a thickness of between about 1 millimetre and about 3 millimetres. The frame may have a width of at least about 10 millimetres. The frame may have a width of at most about 30 millimetres. The frame may have a width of between about 10 millimetres and about 30 millimetres. The frame may have a length of at least about 30 millimetres. The frame may have a length of at most about 50 millimetres. The frame may have a length of between about 30 millimetres and about 50 millimetres.

The perimeter wall may extend from the base in a thickness direction of the frame. The perimeter wall may be aligned along an outer edge of the base. The perimeter wall may be aligned along all sides and ends of the base. When the base is rectangular, the perimeter wall may be aligned along one or both ends of the base. When the base is rectangular, the perimeter wall may be aligned along one or both sides of the base. The perimeter wall may be located at an outer edge of the base. The perimeter wall may extend along a circumference of the base. The perimeter wall may extend along a majority of a circumference of the base. The perimeter wall may extend along all of the circumference of the base which is not occupied by the inlet or the outlet. The perimeter wall may be disposed on the same surface of the base as the aerosol-generating substrate.

The perimeter wall may comprise or consist of cellulose material or a cellulose-based material. The perimeter wall may comprise or consist of a paper-based material. The cellulose material may be one or more of: paper, cellulose acetate. The perimeter wall may comprise one or more of: a porous or fibrous material, cellulose acetate, synthetic fibers, polyester, bonded polyolefin, polyethylene, terylene, polyethylene terephthalate, polypropylene, a biopolymer, biopolymer fibres, polyamide, nylon, nylon fibres, a ceramic, ceramic fibres.

The perimeter wall may have a perimeter wall thickness in a depth direction. The perimeter wall thickness may be at least about 1 millimetre. The perimeter wall thickness may be at most about 3 millimetres. The perimeter wall thickness may be between about 1 millimetre and about 3 millimetres. The perimeter wall may have a length of at least about 30 millimetres. The perimeter wall may have a length of at most about 50 millimetres. The perimeter wall may have a length of between about 30 millimetres and about 50 millimetres. The perimeter wall may have a width of at least about 10 millimetres. The perimeter wall may have a width of at most about 30 millimetres. The perimeter wall may have a width of between about 10 millimetres and about 30 millimetres.

The inlet and the outlet may be apertures disposed in the perimeter wall. The perimeter wall may have an upstream portion in which the inlet is disposed. The perimeter wall may have a downstream portion in which the outlet is disposed. The upstream and downstream portions may be substantially parallel to each other. The perimeter wall may have first and second side portions which may be substantially parallel to each other.

The perimeter wall may have an inner shape that is substantially the same as an outer edge or outer edges of the aerosol-generating substrate. The perimeter wall may have an inner shape that is larger than an outer edge of the aerosol-generating substrate. There may be a gap between the perimeter wall and an outer edge of the aerosol-generating substrate. There may be a gap between the perimeter wall and all outer edges of the aerosol-generating substrate. The perimeter wall may contour an outer edge or outer edges of the aerosol-generating substrate.

The perimeter wall may comprise a first section and a second section, which may be separated from each other by the inlet and the outlet. The first and second sections may each have a convex portion at a downstream end. The convex portions may be arranged to face each other. The first section may be substantially L-shaped. The first section may extend wholly along one lateral side and partially along another lateral side of the frame. The second section may be substantially U-shaped. The second section may extend wholly along one lateral side and partially along two other lateral sides of the frame. The first and second sections may be co-planar. The first and second sections may be substantially parallel to each other. The recess may be defined between the first and second sections.

The base may be planar. The base may be substantially rectangular. The base may be elongate. The base may be a layer of material. The base may comprise an impermeable material. The base may comprise a biodegradable material. The base may comprise or consist of cellulose material. The cellulose material may be one or more of: paper, cellulose acetate. The base may comprise or consist of a paper-based material. The base may comprise or consist of paper. The base may be a layer of paper. The base may comprise one or more of: paper, a paper-based material, plastic, polyethylene, terylene, polyethylene terephthalate, or polypropylene.

The base may have a base thickness in a depth direction. The base thickness may be at least about 0.05 millimetres. The base thickness may be at most about 0.1 millimetres. The base thickness may be between about 0.05 millimetres and about 0.1 millimetres. The base may have a length of at least about 30 millimetres. The base may have a length of at most about 50 millimetres. The base may have a length of between about 30 millimetres and about 50 millimetres. The base may have a width of at least about 10 millimetres. The base may have a width of at most about 30 millimetres. The base may have a width of between about 10 millimetres and about 30 millimetres.

The perimeter wall may have a perimeter wall thickness in the depth direction. The base thickness may be substantially less than the perimeter wall thickness. The base may be fixedly attached to the perimeter wall. The base may be sealed to the perimeter wall. The base may be hermetically sealed to the perimeter wall.

The inlet may have a length of at least about 10 millimetres. The inlet may have a length of at most about 20 millimetres. The inlet may have a length of between about 10 millimetres and about 20 millimetres. The inlet may have a width of at least about 10 millimetres. The inlet may have a width of at most about 20 millimetres. The inlet may have a width of between about 10 millimetres and about 20 millimetres. The inlet may have a depth of at least about 3 millimetres. The inlet may have a depth of at most about 7 millimetres. The inlet may have a depth of about 5 millimetres. The inlet may have a length of 1 millimetre. The inlet may have a width of 1 millimetre.

The outlet may have a length of at least about 10 millimetres. The outlet may have a length of at most about 20 millimetres. The outlet may have a length of between about 10 millimetres and 20 millimetres. The outlet may have a width of at least about 10 millimetres. The outlet may have a width of at most about 20 millimetres. The outlet may have a width of between about 10 millimetres and 20 millimetres. The outlet may have a depth of at least about 3 millimetres. The outlet may have a depth of at most about 7 millimetres. The outlet may have a depth of about 5 millimetres. The outlet may have a length of 1 millimetre. The outlet may have a width of 1 millimetre.

The outlet may be an aerosol outlet. The outlet may be on a mouthpiece of the aerosol-generating article.

The outlet may be shaped so as to create a Venturi effect. By being shaped so as to create a Venturi effect, the outlet defines a section of an airflow pathway which narrows and then expands. This causes airflow to accelerate and then expand. This has the advantage of cooling air exiting the article, and improving nucleation and aerosol generation.

The opening may be arranged to allow aerosol-generating substrate to be inserted into the frame in a depth direction of the frame.

The article may have an upper surface area, and the opening may occupy at least approximately 50% of the upper surface area, preferably at least approximately 70% of the upper surface area, more preferably at least approximately 80% of the upper surface area.

The opening may have a length of at least about 20 millimetres, preferably at least about 24 millimetres, more preferably at least about 26 millimetres. The opening may have a length of at most about 46 millimetres, preferably at most about 44 millimetres. The opening may have a length of between about 20 millimetres and about 46 millimetres, preferably between about 25 millimetres and about 44 millimetres. The opening may have a width of at least about 4 millimetres, preferably at least about 6 millimetres. The opening may have a width of at most about 36 millimetres, preferably at most about 34 millimetres. The opening may have a width of between about 4 millimetres and about 36 millimetres, preferably between about 6 millimetres and about 34 millimetres.

The opening may be substantially two-dimensional. The opening may have a negligible depth. The opening may be elongate in a longitudinal direction of the frame. The opening may be planar. The opening may be substantially rectangular. The opening may be defined by the perimeter wall. The opening may be defined by an outermost edge of the perimeter wall. The outermost edge may be an outermost edge in the depth direction of the perimeter wall. The perimeter wall may extend from the opening to the base. The opening may have a size that is at least 50% of the planar area of the base. The opening may have a size that is at least 60% of the planar area of the base. The opening may have a size that is at least 70% of the planar area of the base. The opening may have a size that is at least 80% of the planar area of the base.

The recess may have a length of at least about 20 millimetres, preferably at least about 24 millimetres, more preferably at least about 26 millimetres. The recess may have a length of at most about 46 millimetres, preferably at most about 44 millimetres. The recess may have a length of between about 20 millimetres and about 46 millimetres, preferably between about 25 millimetres and about 44 millimetres. The recess may have a width of at least about 4 millimetres, preferably at least about 6 millimetres. The recess may have a width of at most about 36 millimetres, preferably at most about 34 millimetres. The recess may have a width of between about 4 millimetres and about 36 millimetres, preferably between about 6 millimetres and about 34 millimetres. The recess may extend between the opening and the base. The recess may extend from the opening to the base. The recess may have a depth. The depth of the recess may be equal to the thickness of the perimeter wall. The recess depth may be at least about 1 millimetre. The recess depth may be at most about 3 millimetres. The recess depth may be between about 1 millimetre and about 3 millimetres.

The recess may be elongate. The recess may be planar. The recess may define a substantially rectangular longitudinal cross-section. The recess may define a substantially rectangular lateral cross-section. The recess may be defined by the perimeter wall.

The recess may extend over at least 50% of the area of the base. The recess may extend over at least 60% of the area of the base. The recess may extend over at least 70% of the area of the base. The recess may extend over at least 80% of the area of the base.

The inlet may have a cross-sectional area. The opening may have a cross-sectional area. A ratio of the inlet cross-sectional area to the opening cross-sectional area may be between approximately 4:1 and 1:15, preferably between approximately 1:1 and 1:10.

The outlet may have a cross-sectional area. A ratio of the outlet cross-sectional area to the opening cross-sectional area may be between approximately 4:1 and 1:15, preferably between approximately 1:1 and 1:10.

The base may be hermetically sealed to the perimeter wall.

The frame may comprise a biodegradable material. This has the advantage of reducing the cost of managing environmental pollution. The frame may comprise or consist of cellulose material. The frame may comprise a paper-based material. The cellulose material may be one or more of: paper, cellulose acetate.

The aerosol-generating substrate may comprise polyhydric alcohols or mixtures thereof, such as propylene glycol, triethylene glycol, 1,3-butanediol, and glycerine. The aerosol-generating substrate may comprise plant based materials, such as loose tobacco or herbal fibers.

Suitable types of materials for use in the aerosol-generating substrate are described below and include, for example, tobacco cut filler, homogenised tobacco material such as cast leaf, aerosol-generating films and gel compositions.

Preferably, the aerosol-generating substrate comprises tobacco material. In certain preferred embodiments, the aerosol-generating substrate comprises shredded tobacco material. For example, the shredded tobacco material may be in the form of cut filler, as described in more detail below. Alternatively, the shredded tobacco material may be in the form of a shredded sheet of homogenised tobacco material. Suitable homogenised tobacco materials are described below. Within the context of the present specification, the term “cut filler” is used to describe to a blend of shredded plant material, such as tobacco plant material, including, in particular, one or more of leaf lamina, processed stems and ribs, homogenised plant material. The cut filler may also comprise other after-cut, filler tobacco or casing.

Preferably, the cut filler comprises at least 25 percent of plant leaf lamina, more preferably, at least 50 percent of plant leaf lamina, still more preferably at least 75 percent of plant leaf lamina and most preferably at least 90 percent of plant leaf lamina. Preferably, the plant material is one of tobacco, mint, tea and cloves. Most preferably, the plant material is tobacco. However, other plant material may be used, for example other plant material that has the ability to release substances upon the application of heat that can subsequently form an aerosol.

Preferably, the cut filler comprises tobacco plant material comprising lamina of one or more of bright tobacco, dark tobacco, aromatic tobacco and filler tobacco. The term “tobacco” may refer to any plant member of the genus Nicotiana.

In preferred embodiments, the weight of the cut filler is between 25 milligrams and 150 milligrams, preferably between 30 milligrams and 125 milligrams, more preferably between 40 milligrams and 100 milligrams. This amount of cut filler typically allows for sufficient material for the formation of an aerosol during the early puffs.

Preferably, the cut filler is soaked with the aerosol former. Soaking the cut filler can be done by spraying or by other suitable application methods. The aerosol former may be applied to the blend during preparation of the cut filler. For example, the aerosol former may be applied to the blend in the direct conditioning casing cylinder (DCCC). Conventional machinery can be used for applying an aerosol former to the cut filler. Suitable aerosol formers are set out above.

Preferably, the aerosol former in the cut filler comprises one or more of glycerol and propylene glycol. The aerosol former may consist of glycerol or propylene glycol or of a combination of glycerol and propylene glycol.

In other preferred embodiments, the aerosol-generating substrate comprises homogenised plant material, preferably a homogenised tobacco material. As used herein, the term “homogenised plant material” encompasses any plant material formed by the agglomeration of particles of plant. For example, sheets or webs of homogenised tobacco material for the aerosol-generating substrates may be formed by agglomerating particles of tobacco material obtained by pulverising, grinding or comminuting plant material and optionally one or more of tobacco leaf lamina and tobacco leaf stems. The homogenised plant material may be produced by casting, extrusion, paper making processes or other any other suitable processes known in the art. In some embodiments, the homogenised plant material may be in the form of one or more sheets. The homogenised plant material may be in the form of a plurality of pellets or granules. The homogenised plant material may be in the form of a plurality of strands, strips or shreds. The strands of homogenised plant material may be formed from a sheet of homogenised plant material, for example by cutting or shredding, or by other methods, for example, by an extrusion method.

The one or more sheets as described herein may each individually have a thickness of between 100 micrometres and 600 micrometres, preferably between 150 micrometres and 300 micrometres, and most preferably between 200 micrometres and 250 micrometres. Individual thickness refers to the thickness of the individual sheet, whereas combined thickness refers to the total thickness of all sheets that make up the aerosol-generating substrate.

The one or more sheets as described herein may have been one or more of crimped, folded, gathered and pleated.

The one or more sheets of homogenised plant material may be cut into strands as referred to above. In such embodiments, the aerosol-generating substrate comprises a plurality of strands of the homogenised plant material. The strands may be used to form a plug. Typically, the width of such strands is about 5 millimetres, or about 4 millimetres, or about 3 millimetres, or about 2 millimetres or less. The length of the strands may be greater than about 5 millimetres, between about 5 millimetres to about 15 millimetres, about 8 millimetres to about 12 millimetres, or about 12 millimetres. Preferably, the strands have substantially the same length as each other.

The homogenised plant material may comprise between 2.5 percent and 95 percent by weight of plant particles, or between 5 percent and 90 percent by weight of plant particles, or between 10 percent and 80 percent by weight of plant particles, or between 15 percent and 70 percent by weight of plant particles, or between 20 percent and 60 percent by weight of plant particles, or between 30 percent and 50 percent by weight of plant particles, on a dry weight basis.

In certain embodiments, the homogenised plant material is a homogenised tobacco material comprising tobacco particles. Sheets of homogenised tobacco material for use in such embodiments may have a tobacco content of at least about 40 percent by weight on a dry weight basis, more preferably of at least about 50 percent by weight on a dry weight basis more preferably at least about 70 percent by weight on a dry weight basis and most preferably at least about 90 percent by weight on a dry weight basis.

The term “tobacco particles” may describe particles of any plant member of the genus Nicotiana. The term “tobacco particles” encompasses ground or powdered tobacco leaf lamina, ground or powdered tobacco leaf stems, tobacco dust, tobacco fines, and other particulate tobacco by-products formed during the treating, handling and shipping of tobacco. In a preferred embodiment, the tobacco particles are substantially all derived from tobacco leaf lamina. By contrast, isolated nicotine and nicotine salts are compounds derived from tobacco but are not considered tobacco particles for purposes of this disclosure and are not included in the percentage of particulate plant material.

The aerosol-generating substrate may comprise nicotine. As used herein, the term “nicotine” is used to describe nicotine, a nicotine base or a nicotine salt. In embodiments in which the aerosol-generating substrate comprises a nicotine base or a nicotine salt, the amounts of nicotine recited herein are the amount of free base nicotine or amount of protonated nicotine, respectively.

The aerosol-generating substrate may comprise between 0.5 percent and 10 percent by weight of nicotine, or between 1 percent and 8 percent by weight of nicotine, or between 2 percent and 6 percent by weight of nicotine, on a dry weight basis.

The aerosol-generating substrate may be substantially tobacco free.

Preferably, the aerosol-generating substrate is in the form of an aerosol-generating film comprising a cellulosic based film forming agent, nicotine and the aerosol former. The aerosol-generating film may further comprise a cellulose based strengthening agent. The aerosol-generating film may further comprise water, preferably 30 percent by weight or less of water.

The term “cellulose based film-forming agent” is used to describe a cellulosic polymer capable, by itself or in the presence of an auxiliary thickening agent, of forming a continuous film.

Preferably, the cellulose based film-forming agent is selected from the group consisting of hydroxypropyl methylcellulose (HPMC), methylcellulose (MC), ethylcellulose (EC), hydroxyethyl methyl cellulose (HEMC), hydroxyethyl cellulose (HEC), hydroxypropyl cellulose (HPC), and combinations thereof. More preferably, the cellulose based film-forming agent is selected from the group consisting of hydroxypropyl methylcellulose (HPMC), methylcellulose (MC), ethylcellulose (EC), and combinations thereof.

Preferably, the aerosol-generating film further comprises a cellulose based strengthening agent. Preferably, the cellulose based strengthening agent is selected from the group consisting of cellulose fibres, microcrystalline cellulose (MCC), cellulose powder, and combinations thereof.

The aerosol-generating film may have a cellulose based strengthening agent content of between 0.5 percent and 40 percent by weight on a dry weight basis, or between 5 percent and 30 percent by weight on a dry weight basis, or between 10 percent and 25 percent by weight on a dry weight basis.

The aerosol-generating film may further comprise a carboxymethyl cellulose, preferably sodium carboxymethyl cellulose.

The aerosol-generating film may have a carboxymethyl cellulose content of between 1 percent and 15 percent by weight, or between 2 percent and 12 percent by weight, or between 4 percent and 10 percent by weight on a dry weight basis.

The aerosol-generating film preferably comprises nicotine.

In embodiments in which the aerosol-generating film comprises a nicotine base or a nicotine salt, the amounts of nicotine recited herein are the amount of free base nicotine or amount of protonated nicotine, respectively.

The aerosol-generating film may comprise natural nicotine or synthetic nicotine.

The aerosol-generating film may comprise one or more monoprotic nicotine salts.

As used herein, the term “monoprotic nicotine salt” is used to describe a nicotine salt of a monoprotic acid.

Preferably, the aerosol-generating film comprises at least 0.5 percent by weight of nicotine on a dry weight basis. More preferably, the aerosol-generating film comprises at least 1 percent by weight of nicotine on a dry weight basis. Even more preferably, the aerosol-generating film comprises at least 2 percent by weight of nicotine on a dry weight basis. In addition, or as an alternative, the aerosol-generating film preferably comprises less than 10 percent by weight of nicotine on a dry weight basis. More preferably, the aerosol-generating film comprises less than 8 percent by weight of nicotine on a dry weight basis. More preferably, the aerosol-generating film comprises less than 6 percent by weight of nicotine on a dry weight basis.

For example, the aerosol-generating film may comprise between 0.5 percent and 10 percent by weight of nicotine, or between 1 percent and 8 percent by weight of nicotine, or between 2 percent and 6 percent by weight of nicotine, on a dry weight basis.

The aerosol-generating film may be a substantially tobacco-free aerosol-generating film.

In preferred embodiments, the aerosol-generating film comprises an acid. More preferably, the aerosol-generating film comprises one or more organic acids. Even more preferably, the aerosol-generating film comprises one or more carboxylic acids. In particularly preferred embodiments, the acid is lactic acid, benzoic acid, fumaric acid or levulinic acid.

Preferably, the aerosol-generating film comprises between 0.25 percent and 3.5 percent by weight of an acid, or between 0.5 percent and 3 percent by weight of an acid, or between 1 percent and 2.5 percent by weight of an acid, on a dry weight basis.

The aerosol-generating film may have a thickness from about 0.1 millimetres to about 1 millimetre, more preferably from about 0.1 millimetres to about 0.75 millimetres, even more preferably from about 0.1 millimetres to about 0.5 millimetres. In particularly preferred embodiments, a layer of the film-forming composition is formed that has a thickness from about 50 micrometres to 400 micrometres, more preferably from about 100 micrometres to 200 micrometres.

The aerosol-generating film may optionally be provided within the second aerosol-generating segment on a suitable carrier element.

In alternative embodiments, the second aerosol-generating substrate may comprise a gel composition that includes nicotine, at least one gelling agent and the aerosol former. The gel composition is preferably substantially tobacco free.

The preferred weight ranges for nicotine in the gel composition are the same as those defined above in relation to aerosol-generating films.

The gel composition preferably comprises at least 50 percent by weight of aerosol former, more preferably at least 60 percent by weight, more preferably at least 70 percent by weight of aerosol former, on a dry weight basis. The gel composition may comprise up to 80 percent by weight of aerosol former. The aerosol former in the gel composition is preferably glycerol.

The gel composition preferably includes at least one gelling agent. Preferably, the gel composition includes a total amount of gelling agents in a range from about 0.4 percent by weight to about 10 percent by weight, or from about 0.5 percent by weight to about 8 percent by weight, or from about 1 percent by weight to about 6 percent by weight, or from about 2 percent by weight to about 4 percent by weight, or from about 2 percent by weight to about 3 percent by weight.

The term “gelling agent” refers to a compound that homogeneously, when added to a 50 percent by weight water/50 percent by weight glycerol mixture, in an amount of about 0.3 percent by weight, forms a solid medium or support matrix leading to a gel. Gelling agents include, but are not limited to, hydrogen-bond crosslinking gelling agents, and ionic crosslinking gelling agents.

The term “hydrogen-bond crosslinking gelling agent” refers to a gelling agent that forms non-covalent crosslinking bonds or physical crosslinking bonds via hydrogen bonding.

The hydrogen-bond crosslinking gelling agent may include one or more of a galactomannan, gelatin, agarose, or konjac gum, or agar. The hydrogen-bond crosslinking gelling agent may preferably include agar.

The term “ionic crosslinking gelling agent” refers to a gelling agent that forms non-covalent crosslinking bonds or physical crosslinking bonds via ionic bonding.

The ionic crosslinking gelling agent may include low acyl gellan, pectin, kappa carrageenan, iota carrageenan or alginate. The ionic crosslinking gelling agent may preferably include low acyl gellan.

The gelling agent may include one or more biopolymers. The biopolymers may be formed of polysaccharides.

Biopolymers include, for example, gellan gums (native, low acyl gellan gum, high acyl gellan gums with low acyl gellan gum being preferred), xanthan gum, alginates (alginic acid), agar, guar gum, and the like. The composition may preferably include xanthan gum. The composition may include two biopolymers. The composition may include three biopolymers. The composition may include the two biopolymers in substantially equal weights. The composition may include the three biopolymers in substantially equal weights.

The gel composition may further include a viscosifying agent. The viscosifying agent combined with the hydrogen-bond crosslinking gelling agent and the ionic crosslinking gelling agent appears to surprisingly support the solid medium and maintain the gel composition even when the gel composition comprises a high level of glycerol.

The term “viscosifying agent” refers to a compound that, when added homogeneously into a 25° C., 50 percent by weight water/50 percent by weight glycerol mixture, in an amount of 0.3 percent by weight., increases the viscosity without leading to the formation of a gel, the mixture staying or remaining fluid.

The gel composition preferably includes the viscosifying agent in a range from about 0.2 percent by weight to about 5 percent by weight, or from about 0.5 percent by weight to about 3 percent by weight, or from about 0.5 percent by weight to about 2 percent by weight, or from about 1 percent by weight to about 2 percent by weight.

The viscosifying agent may include one or more of xanthan gum, carboxymethyl-cellulose, microcrystalline cellulose, methyl cellulose, gum Arabic, guar gum, lambda carrageenan, or starch. The viscosifying agent may preferably include xanthan gum.

The gel composition may further include a divalent cation. Preferably the divalent cation includes calcium ions, such as calcium lactate in solution. Divalent cations (such as calcium ions) may assist in the gel formation of compositions that include gelling agents such as the ionic crosslinking gelling agent, for example. The ion effect may assist in the gel formation. The divalent cation may be present in the gel composition in a range from about 0.1 to about 1 percent by weight, or about 0.5 percent by weight t.

The gel composition may further include an acid. The acid may comprise a carboxylic acid. The carboxylic acid may include a ketone group. Preferably the carboxylic acid may include a ketone group having less than about 10 carbon atoms, or less than about 6 carbon atoms or less than about 4 carbon atoms, such as levulinic acid or lactic acid. Preferably this carboxylic acid has three carbon atoms (such as lactic acid).

The gel composition preferably comprises some water. The gel composition is more stable when the composition comprises some water.

Preferably the gel composition comprises between about 8 percent by weight to about 32 percent by weight water, or from about 15 percent by weight to about 25 percent by weight water, or from about 18 percent by weight to about 22 percent by weight water, or about 20 percent by weight water.

Preferably, where a gel composition is used, the second aerosol-generating substrate comprises a porous medium loaded with the gel composition. Advantages of a porous medium loaded with the gel composition is that the gel composition is retained within the porous medium, and this may aid manufacturing, storage or transport of the gel composition. It may assist in keeping the desired shape of the gel composition, especially during manufacture, transport, or use.

The term “porous” is used herein to refer to a material that provides a plurality of pores or openings that allow the passage of air through the material.

The porous medium may be any suitable porous material able to hold or retain the gel composition. Ideally the porous medium can allow the gel composition to move within it. In specific embodiments the porous medium comprises natural materials, synthetic, or semi-synthetic, or a combination thereof. In specific embodiments the porous medium comprises sheet material, foam, or fibres, for example loose fibres; or a combination thereof. In specific embodiments the porous medium comprises a woven, non-woven, or extruded material, or combinations thereof. Preferably the porous medium comprises, cotton, paper, viscose, PLA, or cellulose acetate, of combinations thereof. Preferably the porous medium comprises a sheet material, for example, cotton or cellulose acetate. In a particularly preferred embodiment, the porous medium comprises a sheet made from cotton fibres. The porous medium may be crimped or shredded. The porous medium may be in the form of a sheet, thread or tubular element.

The aerosol-generating substrate may be flat. The aerosol-generating substrate may be planar. This has the advantage of allowing the aerosol-generating substrate to be efficiently heated by a heating element, and improving the yield of aerosol generated from the aerosol-generating substrate. By having a large surface area to volume ratio, and by having a reduced thickness compared to its length and width, a heating element can be located such that all of the aerosol-generating substrate is within a specified distance from the heating element. This has the advantage of providing an improved user experience and reducing wasted aerosol-generating substrate in use.

The aerosol-generating substrate may be substantially aligned with the planar frame. A plane in which the aerosol-generating substrate extends may be substantially aligned with or substantially parallel to a plane in which the planar frame extends.

The aerosol-generating substrate may have a thickness which is less than the frame thickness. The aerosol-generating substrate may be disposed on an adhesive. The combined thickness of the adhesive and the aerosol-generating substrate may be less than the frame thickness. The aerosol-generating substrate may have a thickness which is less than the perimeter wall thickness. The aerosol-generating substrate may be disposed on an adhesive, and the combined thickness of the adhesive and the aerosol-generating substrate may be less than the perimeter wall thickness. The aerosol-generating substrate may have a thickness such that when the aerosol-generating substrate is disposed in the recess, there is a gap between an upper surface of the aerosol-generating substrate and an upper surface of the frame. When the aerosol-generating substrate is disposed in the recess, there may be a gap between an upper surface of the aerosol-generating substrate and an upper surface of the perimeter wall.

The aerosol-generating substrate may have a thickness of at least about 0.1 millimetres. The aerosol-generating substrate may have a thickness of at most about 5 millimetres. The aerosol-generating substrate may have a thickness of between about 0.1 millimetres and about 5 millimetres. The aerosol-generating substrate may have a width of at least about 10 millimetres. The aerosol-generating substrate may have a width of at most about 20 millimetres. The aerosol-generating substrate may have a width of between about 10 millimetres and about 20 millimetres. The aerosol-generating substrate may have a length of at least about 10 millimetres. The aerosol-generating substrate may have a length of at most about 20 millimetres. The aerosol-generating substrate may have a length of between about 10 millimetres and about 20 millimetres.

The aerosol-generating substrate may have a top surface area. The top surface of the aerosol-generating substrate may be a surface of the aerosol-generating substrate facing away from the base. The opening may have a cross-sectional area. The substrate top surface area may be less than the opening cross-sectional area. The opening may have a cross-sectional area. A ratio of the substrate top surface area to the opening cross-sectional area may be at least approximately 1:2, preferably at least approximately 1:1.5, more preferably at least approximately 1:1.2. The substrate top surface area may be at least approximately 50% of the opening cross-sectional area, preferably at least approximately 70% of the opening cross-sectional area, more preferably at least approximately 80% of the opening cross-sectional area.

The aerosol-generating article may comprise adhesive configured to attach the aerosol-generating substrate to the frame. The adhesive may comprise two or more regions of adhesive. The adhesive may be polyvinyl acetate.

The aerosol-generating substrate may comprise a plurality of aerosol-generating segments. Two or more of the aerosol-generating segments may have the same shape, size, colour or texture (or more than one of these parameters) as each other. Two or more of the aerosol-generating segments may have the same top surface area as each other. This has the advantage of allowing flexibility in the selection and position of aerosol-generating segments by a user. Two or more of the aerosol-generating segments may have the same bottom surface area as each other. The bottom surface area may be closer to the base of the frame in use than the top surface area.

Two or more of the aerosol-generating segments may have a different shape, size, colour or texture (or more than one of these parameters) to each other. This has the advantage of allowing a user to identify the content of the segment by its shape, size, colour or texture. One or more segments comprising nicotine may have a different shape, size, colour or texture to one or more segments comprising less nicotine. One or more segments comprising nicotine may have a different shape, size, colour or texture to one or more segments configured to provide a flavour such as menthol to a user.

The aerosol-generating substrate may comprise a first aerosol-generating segment. The first aerosol-generating segment may comprise a first aerosol-generating substrate. The aerosol-generating substrate may comprise a second aerosol-generating segment. The second aerosol-generating segment may comprise a second aerosol-generating substrate. The first aerosol-generating substrate may have one or both of a lower aerosol former content and a lower bulk density than the second aerosol-generating substrate. At least a portion of the second aerosol-generating segment may be located at a location upstream of at least a portion of the first aerosol-generating segment.

The first and second aerosol-generating substrates may comprise the same aerosol former or aerosol formers as each other, or different aerosol formers may be used.

The first and second aerosol-generating segments may comprise or consist of the first and second aerosol-generating substrates, respectively. The first and second aerosol-generating substrates may comprise non-aerosol-generating material as well as aerosol-generating material.

Optionally, the aerosol former content of the first aerosol-generating substrate is between 10 and 30 percent, preferably between 10 and 25 percent, more preferably between 10 and 20 percent, by weight on a dry weight basis. Optionally, the aerosol former content of the second aerosol-generating substrate is between 40 and 80 percent, preferably between 45 and 75 percent, more preferably between 50 and 70 percent, by weight on a dry weight basis.

Optionally, the first aerosol-generating substrate has a bulk density of between 100 and 400 milligrams per cubic centimetre, preferably between 150 and 350 milligrams per cubic centimetre. Optionally, the second aerosol-generating substrate has a bulk density of between 500 and 1000 milligrams per cubic centimetre, preferably between 550 and 900 milligrams per cubic centimetre. Optionally, the bulk density of the second aerosol-generating substrate is at least 1.1, 1.2, 1.5, 2 or 2.5 times the bulk density of the first aerosol-generating substrate.

Optionally, the first aerosol-generating substrate has both a lower aerosol former content and a lower bulk density than the second aerosol-generating substrate.

Optionally, the aerosol former content of the second aerosol-generating substrate is at least 2.5 times the aerosol former content of the first aerosol-generating substrate by weight on a dry weight basis; and the bulk density of the second aerosol-generating substrate is at least 2.5 times the bulk density of the first aerosol-generating substrate.

Optionally, the aerosol former content of the first aerosol-generating substrate is no more than 20 percent by weight on a dry weight basis, and the aerosol former content of the second aerosol-generating substrate is at least 50 percent by weight on a dry weight basis; and the first aerosol-generating substrate has a bulk density of less than 300 milligrams per cubic centimetre, and the second aerosol-generating substrate has a bulk density of at least 600 milligrams per cubic centimetre.

Optionally, at least a portion of the second aerosol-generating segment is located upstream of at least a portion of the first aerosol-generating segment. Optionally, the second aerosol-generating segment is located upstream of the first aerosol-generating segment. Optionally, an entirety of the second aerosol-generating segment is located upstream of an entirety the first aerosol-generating segment.

Optionally, the second aerosol-generating segment is spaced from, for example upstream of, the first aerosol-generating segment by at least 0.5, 1 or 2 millimetres. Optionally, the second aerosol-generating segment is spaced from, for example upstream of, the first aerosol-generating segment by no more than 10, 5 or 2 millimetres. Optionally, the second aerosol-generating segment is spaced from, for example upstream of, the first aerosol-generating segment by between 0.5 and 5, preferably between 0.5 and 2, millimetres.

The first aerosol-generating segment may have a first length, a first width, and a first thickness. The first thickness may be no more than 0.5, preferably no more than 0.2, more preferably no more than 0.1, times the first length. The first thickness may be no more than 0.5, preferably no more than 0.2, more preferably no more than 0.1, times the first width.

The second aerosol-generating segment may have a second length, a second width, and a second thickness. The second thickness may be no more than 0.5, preferably no more than 0.2, more preferably no more than 0.1, times the second length. The second thickness may be no more than 0.5, preferably no more than 0.2, more preferably no more than 0.1, times the second width.

Optionally, one or both of the first aerosol-generating segment and the second aerosol-generating segment is prismatic in shape, for example cuboid or right cylindrical in shape. Optionally, the first aerosol-generating segment and the second aerosol-generating segment are identical in shape.

Optionally, one or both of the first aerosol-generating segment and the second aerosol-generating segment has a thickness of at least 0.05, 0.1, or 0.2 millimetres. Optionally, one or both of the first aerosol-generating segment and the second aerosol-generating segment has a thickness no more than 5, 4, or 3 millimetres. Optionally, one or both of the first aerosol-generating segment and the second aerosol-generating segment has a thickness of between 0.1 and 5, preferably between 0.2 and 4, millimetres. Advantageously, such thicknesses may provide a good compromise between the segment being sufficiently thick to contain a reasonable quantity of aerosol-generating substrate, but sufficiently thin to allow substrate furthest from a heater to be heated to a sufficiently high temperature to generate an aerosol without a significant risk of burning the substrate closest to the heater.

Optionally, one or both of the first aerosol-generating segment and the second aerosol-generating segment has a width of at least 5 or 10 millimetres. Optionally, one or both of the first aerosol-generating segment and the second aerosol-generating segment has a width no more than 30 or 20 millimetres. Optionally, one or both of the first aerosol-generating segment and the second aerosol-generating segment has a width of between 10 and 20 millimetres.

Optionally, one or both of the first aerosol-generating segment and the second aerosol-generating segment has a length of at least 5 or 10 millimetres. Optionally, one or both of the first aerosol-generating segment and the second aerosol-generating segment has a length no more than 30 or 20 millimetres. Optionally, one or both of the first aerosol-generating segment and the second aerosol-generating segment has a length of between 10 and 20 millimetres.

Advantageously, such widths and lengths may be particularly suitable for insertion of the segment or segments into the frame via the opening. Such widths and lengths allow the user to locate one or both of the aerosol-generating segments easily within the recess, while being large enough to efficiently generate a suitable amount of aerosol. Advantageously, such widths and lengths may also comfortably fit within an article which is a comfortable size for a user to hold between their fingers, whilst still providing a sufficient quantity of substrate to generate enough aerosol to satisfy a user during a usage session.

The aerosol-generating article may be configured to removably connect to an aerosol-generating device. The aerosol-generating article may be sized or shaped (or sized and shaped) to removably connect to an aerosol-generating device.

The aerosol-generating article may be provided in an aerosol-generating system. The aerosol-generating system may comprise an aerosol-generating device. The aerosol-generating device may have a heating element configured to heat the aerosol-generating substrate to form an aerosol. The aerosol-generating device may have a device housing defining a cavity. The aerosol-generating article may be disposed in the device housing cavity. The aerosol-generating article may be disposed in the device housing cavity to define an air flow passage between the device housing and the frame of the article. The air flow passage may extend from the inlet to the outlet.

The heating element may be substantially planar. The heating element may be substantially aligned with the aerosol-generating substrate. A plane of the heating element may be substantially aligned with or substantially parallel to a plane of the aerosol-generating substrate.

The aerosol-generating system may comprise a plurality of heating elements. The aerosol-generating system may comprise a number of heating elements which correspond to the number of aerosol-generating substrate segments of the aerosol-generating article. This has the advantage of allowing the aerosol-generating segments to be subjected to the same or different temperature profiles in use. The aerosol-generating system may be configured in use to heat the aerosol-generating substrate up to a temperature of approximately 250 degrees Celsius.

The aerosol-generating article may be configured to be wholly or partially inserted into the aerosol-generating device. The aerosol-generating article may be configured to be wholly or partially inserted into the aerosol-generating device housing cavity. The aerosol-generating article may be configured so that the opening of the frame is partially or wholly closed by a wall of the device housing cavity. The aerosol-generating article may be configured so that the frame contacts a wall of the device housing cavity when the aerosol-generating article is inserted into the device. The aerosol-generating article may be configured so that the perimeter wall contacts a wall of the device housing cavity when the aerosol-generating article is inserted into the aerosol-generating device. The aerosol-generating article may be configured so that when the article is inserted into the aerosol-generating device, the perimeter wall extends from a wall of the device housing cavity to the planar base of the frame. The aerosol-generating article may be configured so that when the article is inserted into the device the perimeter wall forms a seal with a wall of the device housing cavity. The aerosol-generating article may be configured so that when the article is inserted into the aerosol-generating device, the aerosol-generating substrate is encased between a wall of the device housing cavity, the perimeter wall of the frame, and the planar base of the frame. The aerosol-generating article may be configured so that when the article is inserted into the aerosol-generating device, an air flow pathway is defined between the device and the aerosol-generating article. The aerosol-generating article may be configured so that when the aerosol-generating article is inserted into the aerosol-generating device, an air flow pathway is defined between the device and the planar base. The aerosol-generating article may be configured so that when the aerosol-generating article is inserted into the aerosol-generating device, air can pass from the inlet, towards and over the aerosol-generating substrate within the recess, and out of the outlet. As air flows over the aerosol-generating substrate, it may be between a wall of the device cavity and the base of the frame of the aerosol-generating article.

The invention is defined in the claims. However, below there is provided a non-exhaustive list of non-limiting examples. Any one or more of the features of these examples may be combined with any one or more features of another example, embodiment, or aspect described herein.
Example Ex 1. An aerosol-generating article for use with an aerosol-generating device to form an inhalable aerosol, the aerosol-generating article comprising a planar frame and an aerosol-generating substrate,
the planar frame comprising:
   a top surface, a bottom surface and lateral sides;
   an inlet disposed on a lateral side,
   an outlet disposed on a lateral side opposing the inlet;
   a recess between the inlet and the outlet;
   and an opening on the top surface;
wherein the aerosol-generating substrate is disposed in the recess, and the aerosol-generating substrate is smaller than the opening.
Example Ex 2. An aerosol-generating article according to Example Ex 1, wherein the frame comprises a planar base and a perimeter wall, the base and the perimeter wall defining the recess.
Example Ex 3. An aerosol-generating article according to Example Ex 2, wherein the inlet and the outlet are apertures disposed in the perimeter wall.
Example Ex 4. An aerosol-generating article according to Example Ex 2 or Example Ex 3, wherein the perimeter wall has an upstream portion in which the inlet is disposed, a downstream portion in which the outlet is disposed, and the upstream and downstream portions are substantially parallel to each other.
Example Ex 5. An aerosol-generating article according to any of Examples Ex 2 to Ex 4, wherein the perimeter wall has first and second side portions which are substantially parallel to each other.
Example Ex 6. An aerosol-generating article according to any of Examples Ex 1 to Ex 5, wherein the frame has a substantially parallelepiped shape.
Example Ex 7. An aerosol-generating article according to any of Examples Ex 1 to Ex 6, wherein the frame is elongate along a frame length, and the inlet and outlet are disposed on opposite ends of the frame length.
Example Ex 8. An aerosol-generating article according to any of Examples Ex 1 to Ex 7, wherein the frame has a length, a width and a depth, the length being bigger than each of the width and the depth, and the inlet and outlet are disposed on opposite ends of the length of the frame.
Example Ex 9. An aerosol-generating article according to any of Examples Ex 1 to Ex 8, wherein a ratio of the frame width to the frame thickness is between about 3:1 and 30:1.
Example Ex 10. An aerosol-generating article according to any of Examples Ex 1 to Ex 9, wherein a ratio of the frame length to the frame width is between about 1:1 and 5:1.
Example Ex 11. An aerosol-generating article according to any of Examples Ex 1 to Ex 10, wherein the frame has a thickness of between about 1 millimetres and 3 millimetres.
Example Ex 12. An aerosol-generating article according to any of Examples Ex 1 to Ex 11, wherein the frame has a width of between about 10 millimetres and 30 millimetres.
Example Ex 13. An aerosol-generating article according to any of Examples Ex 1 to Ex 12, wherein the frame has a length of between about 30 millimetres and 50 millimetres.
Example Ex 14. An aerosol-generating article according to any of Examples Ex 1 to Ex 13, comprising adhesive configured to attach the aerosol-generating substrate to the frame.
Example Ex 15. An aerosol-generating article according to any of Examples Ex 2 to Ex 14, wherein the base has a base thickness in a depth direction, the perimeter wall has a perimeter wall thickness in the depth direction, and the base thickness is substantially less than the perimeter wall thickness.
Example Ex 16. An aerosol-generating article according to any of Examples Ex 1 to Ex 15, wherein the inlet has a length of between about 10 millimetres and 20 millimetres.
Example Ex 17. An aerosol-generating article according to any of Examples Ex 1 to Ex 16, wherein the inlet has a width of between about 10 millimetres and 20 millimetres.
Example Ex 18. An aerosol-generating article according to any of Examples Ex 1 to Ex 17, wherein the inlet has a depth of about 5 millimetres.
Example Ex 19. An aerosol-generating article according to any of Examples Ex 1 to Ex 18, wherein the outlet has a length of between about 10 millimetres and 20 millimetres.
Example Ex 20. An aerosol-generating article according to any of Examples Ex 1 to Ex 19, wherein the outlet has a width of between about 10 millimetres and 20 millimetres.
Example Ex 21. An aerosol-generating article according to any of Examples Ex 1 to Ex 20, wherein the outlet has a depth of about 5 millimetres.
Example Ex 22. An aerosol-generating article according to any of Examples Ex 1 to Ex 21, wherein the opening has a length of at least about 20 millimetres.
Example Ex 23. An aerosol-generating article according to any of Examples Ex 1 to Ex 22, wherein the opening has a width of at least about 4 millimetres.
Example Ex 24. An aerosol-generating article according to any of Examples Ex 1 to Ex 23, wherein the recess has a depth of between about 1 millimetre and about 3 millimetres.
Example Ex 25. An aerosol-generating article according to any of Examples Ex 1 to Ex 24, wherein the inlet has a cross-sectional area, the opening has a cross-sectional area, and a ratio of the inlet cross-sectional area to the opening cross-sectional area is between approximately 1:1 and 1:10.
Example Ex 26. An aerosol-generating article according to any of Examples Ex 1 to Ex 25, wherein the outlet has a cross-sectional area, the opening has a cross-sectional area, and a ratio of the outlet cross-sectional area to the opening cross-sectional area is between approximately 1:1 and 1:10.
Example Ex 27. An aerosol-generating article according to any of Examples Ex 2 to Ex 26, wherein the base is hermetically sealed to the perimeter wall.
Example Ex 28. An aerosol-generating article according to any of Examples Ex 1 to Ex 27, wherein the frame comprises a biodegradable material.
Example Ex 29. An aerosol-generating article according to any of Examples Ex 1 to Ex 28, wherein the frame comprises cellulose material.
Example Ex 30. An aerosol-generating article according to Example Ex 29, wherein the cellulose material is one or more of: paper, cellulose acetate.
Example Ex 31. An aerosol-generating article according to any of Examples Ex 1 to Ex 30, wherein the aerosol-generating substrate is planar.
Example Ex 32. An aerosol-generating article according to any of Examples Ex 1 to Ex 31, wherein the aerosol-generating substrate is configured to generate an aerosol when heated up to a temperature of approximately 250 degrees Celsius.
Example Ex 33. An aerosol-generating article according to any of Examples Ex 1 to Ex 32, wherein the aerosol-generating substrate has a thickness which is less than the frame thickness.
Example Ex 34. An aerosol-generating article according to any of Examples Ex 2 to Ex 33, wherein the aerosol-generating substrate has a thickness which is less than the perimeter wall thickness.
Example Ex 35. An aerosol-generating article according to any of Examples Ex 1 to Ex 34, wherein the aerosol-generating substrate has a thickness of between about 0.1 millimetres and 5 millimetres.
Example Ex 36. An aerosol-generating article according to any of Examples Ex 1 to Ex 35, wherein the aerosol-generating substrate has a width of between about 10 millimetres and 20 millimetres.
Example Ex 37. An aerosol-generating article according to any of Examples Ex 1 to Ex 38, wherein the aerosol-generating substrate has a length of between about 10 millimetres and 20 millimetres.
Example Ex 38. An aerosol-generating article according to any of Examples Ex 1 to Ex 37, wherein the aerosol-generating substrate has a top surface area, the opening has a cross-sectional area, and the substrate top surface area is less than the opening cross-sectional area.
Example Ex 39. An aerosol-generating article according to any of Examples Ex 1 to Ex 38, wherein the aerosol-generating substrate has a top surface area, the opening has a cross-sectional area, and the ratio of the substrate top surface area to the opening cross-sectional area is at least approximately 1:2.
Example Ex 40. An aerosol-generating article according to any of Examples Ex 1 to Ex 39, wherein the aerosol-generating substrate comprises a first aerosol-generating segment comprising a first aerosol-generating substrate and a second aerosol-generating segment comprising a second aerosol-generating substrate.
Example Ex 41. An aerosol-generating article according to Example Ex 40, wherein the first aerosol-generating substrate has one or both of a lower aerosol former content and a lower bulk density than the second aerosol-generating substrate.
Example Ex 42. An aerosol-generating article according to Example Ex 40 or Example Ex 41, wherein at least a portion of the second aerosol-generating segment is located at a location upstream of at least a portion of the first aerosol-generating segment.
Example Ex 43. An aerosol-generating system, comprising:
a device having a heating element configured to heat the aerosol-generating substrate to form an aerosol, and a device housing defining a cavity; and
the aerosol-generating article of any of Examples Ex 1 to Ex 42; and wherein the aerosol-generating article is disposed in the device housing cavity to define a flow passage between the device housing and the frame of the article, the flow passage extending from the inlet to the outlet.

Examples will now be further described with reference to the figures in which:

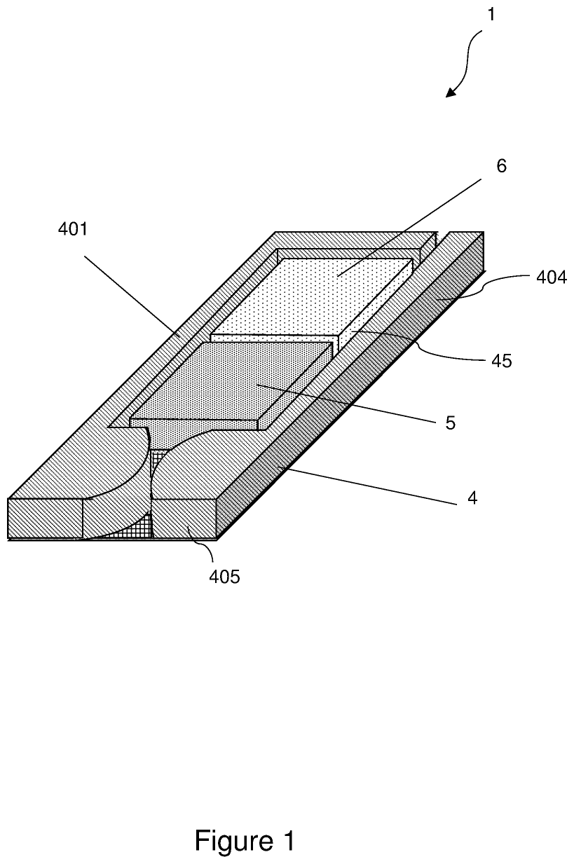

FIG. 1 shows a schematic illustration of an aerosol-generating article according to this disclosure;

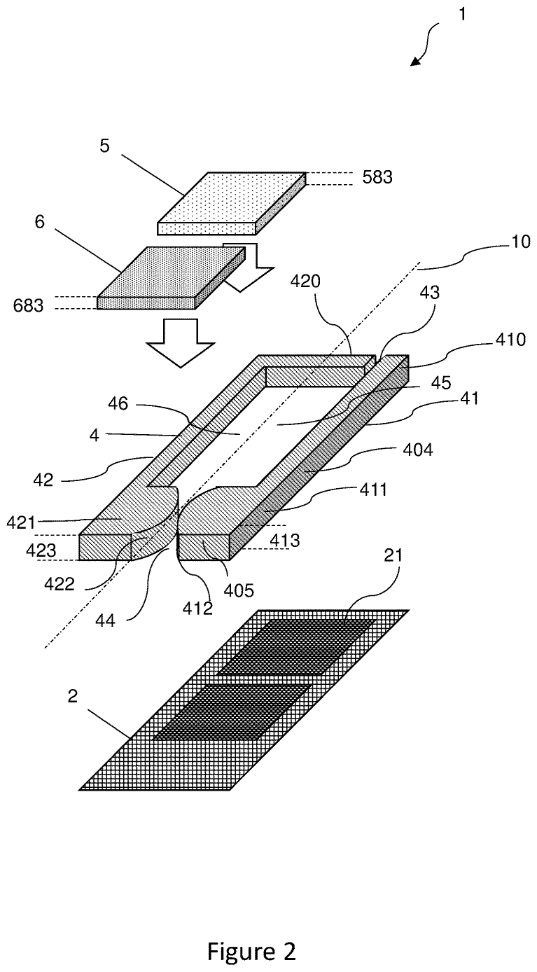

FIG. 2 shows a schematic expanded view illustration of the aerosol-generating article of FIG. 1;

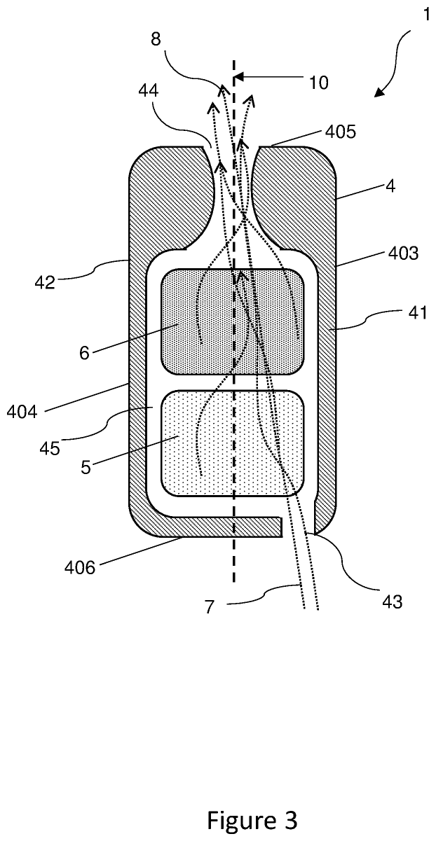

FIG. 3 shows a schematic illustration in plan view of an aerosol-generating article according to this disclosure;

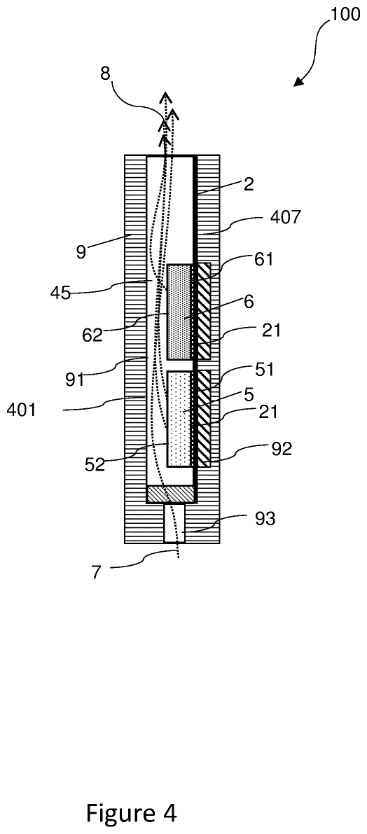

FIG. 4 shows a cross-sectional schematic illustration of an aerosol-generating system according to this disclosure; and

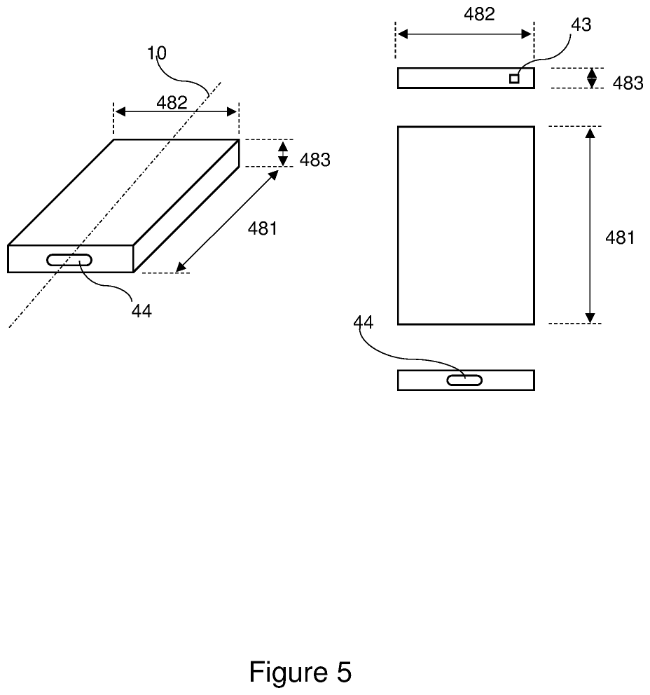

FIG. 5 shows a cross-sectional schematic illustration of an aerosol-generating article according to this disclosure having labelled dimensions.

FIG. 1 shows an aerosol-generating article 1 according to this disclosure. The aerosol-generating article 1 is for use with an aerosol-generating device to form an inhalable aerosol. The aerosol-generating article 1 is a generally flat, planar article, with a rectangular transverse cross-sectional shape.

The aerosol-generating article 1 comprises a planar frame 4 and an aerosol-generating substrate 5, 6. The aerosol-generating substrate 5, 6 is in two segments. The aerosol-generating substrate 5, 6 comprises a first aerosol-generating segment comprising a first aerosol-generating substrate 5 and a second aerosol-generating segment comprising a second aerosol-generating substrate 6. The first aerosol-generating substrate 5 has one or both of a lower aerosol former content and a lower bulk density than the second aerosol-generating substrate 6.

The planar frame 4 comprises a top surface 401, a bottom surface 407 and lateral sides 403, 404, 405, 406. The frame 4 comprises an inlet 43 disposed on a lateral side 406. The frame 4 comprises an outlet 44 disposed on a lateral side 405 opposing the inlet 43. The frame 4 comprises a recess 45 between the inlet 43 and the outlet 44. The frame 4 comprises an opening 46 on the top surface 401. The aerosol-generating substrate 5, 6 is disposed in the recess 45. The aerosol-generating substrate 5, 6 is smaller than the opening 46 and the recess 45.

The frame 4 comprises a planar base 2 and a perimeter wall 41, 42. The base 2 and the perimeter wall 41, 42 define the recess 45. The frame 4 comprises cellulose material. The frame 4 comprises a biodegradable material. The frame 4 comprises two regions of adhesive 21 on the base 2 onto which the two aerosol-generating segments 5, 6 are fixed. A bottom surface 51, 61 of the aerosol-generating segments is fixed to the base 2 via adhesive, as best seen in FIG. 4.

The inlet 43 and the outlet 44 are apertures disposed in the perimeter wall 41, 42. The perimeter wall 41, 42 comprises a first section 41 and a second section 42, separated from each other by the inlet 43 and the outlet 44. The first and second sections 41, 42 each have a convex portion at a downstream end, the convex portions facing each other. The first section 41 is substantially L-shaped. The first section 41 extends wholly along one lateral side 403 and partially along another lateral side 405 of the frame 4. The second section is substantially U-shaped. The second section 42 extends wholly along one lateral side 404 and partially along two other lateral sides 405, 406 of the frame 4. The first and second sections 41, 42 are co-planar. The first and second sections 41, 42 are substantially parallel to each other. The recess 45 is defined between the first and second sections 41, 42.

The aerosol-generating substrate 5, 6 is planar. The aerosol-generating substrate 5, 6, has a thickness 583, 683. The perimeter wall 41, 42 has a thickness 413, 423. The aerosol-generating substrate thickness 583, 683 which is less than the perimeter wall thickness 413, 423. The aerosol-generating substrate 5, 6 has a top surface 52, 62 having a top surface area. The opening 46 has a cross-sectional area. The substrate top surface area is less than the opening cross-sectional area. The ratio of the substrate top surface area to the opening cross-sectional area is at least approximately 1:2. As depicted in FIG. 5, the frame 4 has a frame length 481 along a longitudinal axis 10. The frame 4 is elongate along the frame length 481. The inlet 43 and the outlet 44 are disposed on opposite ends of the frame length 481. The frame 4 has a frame width 482. The frame 4 has a frame thickness 483. A ratio of the frame width 482 to the frame thickness 483 is between about 3:1 and 30:1. A ratio of the frame length 481 to the frame width 482 is between about 1:1 and 5:1.

An aerosol-generating system 100 is shown in FIG. 4. The aerosol-generating system comprises an aerosol-generating device 9. The aerosol-generating device 9 comprises a device cavity into which the aerosol-generating article 1 is inserted, an inner wall 91, an air inlet 93 and a heating element 92.

As best seen in FIG. 4, when the aerosol-generating article 1 is inserted into an aerosol-generating device 9, the opening 46 is closed by the inner wall 91 of the device cavity. In this assembled state, the aerosol-generating substrate 5, 6, is proximate to a heating element 92 of the aerosol-generating device.

In use, when a user draws on the aerosol-outlet 44, air flow 7 is drawn in through the air inlet 93, through the air inlet 43 of the aerosol-generating article, over the heated aerosol-generating substrate 5, 6 where an aerosol is generated, and passes to the outlet 44 as airflow containing aerosol 8.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating article for an aerosol-generating device to form an inhalable aerosol,
the aerosol-generating article comprising a planar frame and an aerosol-generating substrate,
the planar frame comprising:
a top surface, a bottom surface, and lateral sides,
an inlet disposed on a lateral side,
an outlet disposed on a lateral side opposing the inlet,
a recess between the inlet and the outlet, and
an opening on the top surface,
wherein the aerosol-generating substrate is disposed in the recess, and the aerosol-generating substrate is smaller than the opening.

17. The aerosol-generating article according to claim 16, wherein the planar frame further comprises a planar base and a perimeter wall, the planar base and the perimeter wall defining the recess.

18. The aerosol-generating article according to claim 17, wherein the inlet and the outlet are apertures disposed in the perimeter wall.

19. The aerosol-generating article according to claim 16, wherein the planar frame is elongate along a frame length, and the inlet and the outlet are disposed on opposite ends of the frame length.

20. The aerosol-generating article according to claim 16, wherein a ratio of a frame width to a frame thickness is between about 3:1 and 30:1.

21. The aerosol-generating article according to claim 16, wherein a ratio of a frame length to a frame width is between about 1:1 and 5:1.

22. The aerosol-generating article according to claim 16, wherein the planar frame further comprises cellulose material.

23. The aerosol-generating article according to claim 16, wherein the planar frame comprises a biodegradable material.

24. The aerosol-generating article according to claim 16, wherein the aerosol-generating substrate is planar.

25. The aerosol-generating article according to claim 17, wherein the aerosol-generating substrate has a thickness that is less than a thickness of the perimeter wall.

26. The aerosol-generating article according to claim 16, wherein the aerosol-generating substrate has a top surface area, the opening has a cross-sectional area, and the top surface area of the aerosol-generating substrate is less than the cross-sectional area of the opening.

27. The aerosol-generating article according to claim 16, wherein the aerosol-generating substrate has a top surface area, the opening has a cross-sectional area, and a ratio of the top surface area of the aerosol-generating substrate to the cross-sectional area of the opening is at least approximately 1:2.

28. The aerosol-generating article according to claim 16, wherein the aerosol-generating substrate comprises a first aerosol-generating segment comprising a first aerosol-generating substrate and a second aerosol-generating segment comprising a second aerosol-generating substrate.

29. The aerosol-generating article according to claim 28, wherein the first aerosol-generating substrate has one or both of a lower aerosol former content and a lower bulk density than the second aerosol-generating substrate.

30. An aerosol-generating system, comprising:
a device having a heating element configured to heat the aerosol-generating substrate to form an aerosol, and a device housing defining a cavity; and
the aerosol-generating article according to claim 16,
wherein the aerosol-generating article is disposed in the cavity of the device housing to define a flow passage between the device housing and the planar frame of the aerosol-generating article, the flow passage extending from the inlet to the outlet.
